(19) United States
(12) Patent Application Publication
(10) Pub. No.: US 2009/0024545 A1
(43) Pub. Date: Jan. 22, 2009

(54) METHOD AND SYSTEM FOR MEASUREMENT AND CONTROL OF INDIVIDUAL CIRCUITS

(75) Inventors: Brian Golden, Great Falls, VA (US); Karl Lewis, Great Falls, VA (US)

Correspondence Address: GREENBERG TRAURIG, LLP, 2101 L Street, N.W., Suite 1000, Washington, DC, 20037, US

(73) Assignee: GridPoint, Inc., Arlington, VA (US)

(21) Appl. No.: 12/175,327

(22) Filed: Jul. 17, 2008

Related U.S. Application Data
(60) Provisional application No. 60/950,177, filed on Jul. 17, 2007.

(51) Int. Cl. G06F 1/28; G06F 17/00

(52) U.S. Cl. 705/412; 700/297; 700/295; 700/286

(57) ABSTRACT

A power consumption management system. The system includes a power appliance at a consumer site and a power appliance control point at a LSE site. The power appliance is capable of measuring and controlling power consumption on a plurality of circuits located at the consumer site, as well as controlling end consumer devices. The power appliance control point is capable of receiving power consumption data for each of the plurality of consumer circuits, and is capable of commanding the power appliance to control power consumption on individual circuits. The power appliance is further capable of directing power supplied from individual LSE's to individual circuits at the consumer site, and capable of varying such usage according to more complex schemes, for example, by time of day or environmental conditions.

This application claims priority to U.S. Provisional Patent Application No. 60/950,177 filed Jul. 17, 2007, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of electrical power distribution, and in particular to methods and systems for controlling individual electrical circuits and devices.

### BACKGROUND OF THE INVENTION

Utilities and resellers of electrical energy typically measure and control power distribution to individual customer sites using a variety of rates structures and service types. A rate structure may offer varying rates based on usage type, time of usage (peak vs. off-peak), and date of usage. Usage types are typically broad categories, for example, residential service, industrial service, street lighting, and outdoor lighting. Service types are also relatively broad categories, such as normal service and interruptible service (service which the utility may shut down during peak periods.) Control of power distribution is typically at the level of the customer site. Power to the entire site is on, off, or uniformly reduced.

It may be desirable to make the measurement and control of power distribution more fine grained. For example, it may be desirable to charge a customer a higher rate for air conditioning than for essential usage. It may also be desirable to enable a utility to shut down non-essential power usage to a non-paying customer, but allow power consumption for essential usage. Where devices at a customer site are intelligent and can respond to electronic commands, it may be desirable to enable a utility or the customer to automatically power such devices off at certain times of the day.

Moreover, where a customer has access to power from two or more Load Serving Entities (“LSE”), it may be advantageous to the customer to purchase electric power from more than one LSE. LSE's (Load Serving Entities) may have different rates based upon the type and time of usage. For example, one LSE may offer the lowest peak usage rates, while another offers the lowest off-peak usage rates. In another example, one LSE may offer the lowest rates for usage for air conditioning, while another offers the lowest general purpose rate. Rates may vary by season as well, so that, for example, one LSE may have the lowest peak usage rate in summer, but not in winter.

Thus, it may also be desirable for a customer to purchase power from more than one LSE and to have the ability to use power from each source for different purposes.

### SUMMARY OF THE INVENTION

In one embodiment, the invention provides a power consumption management system. The system includes at least one power appliance operatively connected to the network and to a power grid. Each of the power appliances are operatively connected to at least one electrical circuit. The power appliances are configured to receive power from the power grid and distribute the power to electrical circuits, measure power consumption on the electrical circuits and transmit data relating to the power consumption on the electrical circuits over the network. The power appliances are further configured to increase or decrease power supplied to the at least one electrical circuit in response to power consumption commands received over the network. The power consumption management system further includes a power appliance control point operatively connected to the network. The power appliance control point is configured to receive the data relating to power consumption transmitted over the network by the power appliances and to transmit power consumption commands over the network to the power appliances to increase or decrease power supplied to the electrical circuits.

In another embodiment, the invention provides a method for charging a user for power consumption by electrical circuit. A power appliance measures power consumption on each of a plurality of electrical circuits within a user location and transmits data relating to the power consumption on each of electrical circuits to a power appliance control point. Power consumption is metered by the power appliance control point on each of the plurality of electrical circuits, and the user is charged for power consumption on each of the electrical circuits using a rate structure having a rate for each of the of the electrical circuits.

In another embodiment, the invention provides a power consumption management system. The system includes a power appliance operatively connected to the network, to a plurality of power sources and to a plurality of electrical circuits. The power appliance is configured to receive power from the each of the power sources, to separately select, for each of the electrical circuits, one of the power sources, and to distribute power to each electrical circuit from the power source selected for that electrical circuit.

In another embodiment, the invention provides a power appliance at a consumer site and a power appliance control point at a LSE site. The power appliance is capable of measuring and controlling power consumption on a plurality of circuits located at the consumer site, as well as controlling end consumer devices. The power appliance control point is capable of receiving power consumption data for each of the plurality of consumer circuits, and is capable of commanding the power appliance to control power consumption on individual circuits.

In another embodiment, the invention provides a power appliance at a consumer site capable of receiving and redistributing power obtained from a plurality of LSE's. The power appliance is capable of measuring and controlling power consumption on a plurality of circuits located at the consumer site, as well as controlling end consumer devices. The power appliance is further capable of directing power supplied from individual LSE's to individual circuits at the consumer site, and is capable of varying such usage according to more complex schemes, for example, by time of day or environmental conditions.

### BRIEF DESCRIPTION OF THE DRAWINGS

FIG. 1 shows an operational diagram of one embodiment of the invention wherein the invention is used by an LSE to measure and control individual circuits.

FIG. 2 shows an operational diagram of one embodiment of the invention wherein the invention is used by a consumer to obtain power from two LSE's and to direct power to specific circuits.

### DETAILED DESCRIPTION

Reference will now be made in detail to the preferred embodiments of the present invention, examples of which are illustrated in the accompanying drawings.

The present invention is described below with reference to block diagrams and operational illustrations of methods and devices for measuring and controlling the power consumption of individual circuits and electronic devices. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

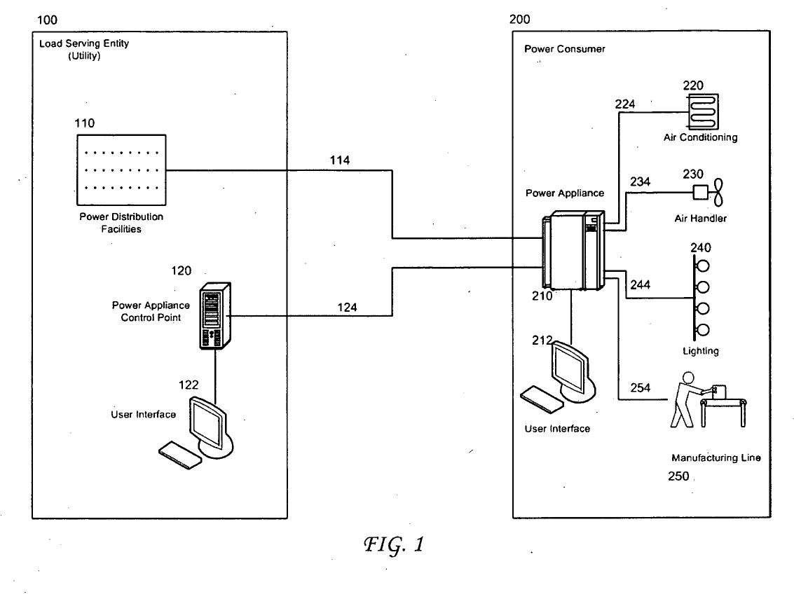

Referring first to FIG. 1, in an embodiment of the invention, a power consumer, 200, for example, a manufacturer, purchases electrical power from a Load Serving Entity, 100, for example, the local utility. Of course, the power consumer 200 may be either a commercial or a residential consumer. At the power consumer 200, one or more power lines, 114, connected to the LSE's power distribution facilities, 110, enter the customer site and are connected to a power appliance, 210. Electrical power is distributed from the power appliance, 220, through the customer site by four electrical circuits, 220, 230, 240, and 250. The circuits are used to provide power to air conditioning, 220, air handlers, 230, lighting, 240, and the manufacturing line, 250, respectively.

A power appliance control point, 120, is connected by a communications link, 124, to the power appliance, 210. The control point, 120, may be a server hosting specialized control software. Alternatively, the control point may be a computer connected to the Internet which accesses control software hosted on the power appliance, or hosted on a third party site. The communications link, 124, may be any form of communications link capable of linking the power appliance control point, 120, and the power appliance, 210, for example, any manner of internet connection, a dedicated line, or a wireless communication link. The power appliance, 210, and the power appliance control point, 120, both have a user interface, 122, and 212 respectively, which may be any manner of computer interface, for example, a GUI on a display screen, a real-time data feed from a separately hosted system, or a batch file.

The power appliance, 210, is capable of individually measuring and controlling power consumption for the four circuits, 224, 234, 244, and 254. Where end consumer devices, such as, for example, air conditioning, 220, are intelligent devices and can be programmed for either simple or complex behavior, the power appliance is capable of sending commands to the devices. For example, air conditioner, 220, may be able to respond to commands from power appliance 210 to increase or decrease temperature. In one embodiment, the power appliance, 210, can be programmed to respond to changes in grid conditions and the status and availability of power from LSEs.

The power appliance control point, 120, is capable of receiving data from the power appliance, 210, regarding power consumption on individual circuits. The power appliance control point, 120, also is capable of issuing commands to the power appliance, 210, for example, to shut down or reduce power to specific circuits, or to issue commands to end consumer devices, for example, commands to the air conditioner to increase or decrease temperature.

The power appliance control point, 120, is further capable of receiving data from the LSE 100 regarding changes in grid conditions and the status and availability of power from the LSE. The power appliance control point, 120, is further capable of transmitting data changes in grid conditions and the status and availability of power from an LSE 100 to the power appliance, 210. Such sources can include data sent from the LSE, 100, to the power appliance control point, 120, over a network (not shown.) In one embodiment, the power appliance control point, 120, is further capable of programming the power appliance, 210, to respond to changes in grid conditions and the status and availability of power from LSE.

Information sent from the power appliance control point 120 to the power appliance 210 may cause the power appliance 210 to change the state of the loads it controls. For example, the power appliance 210 may operate under a set of commands which dictate that a ceiling fan under its control should be energized when data received from the power appliance control point 120 indicates that a wind turbine is operating above a certain threshold. Likewise, another set of rules may dictate a range of operation based upon ranges of operational parameters. For example, the rules may dictate that a thermostat under the control of a power appliance 210 should be set to 72 degrees if a solar array owned by the LSE 100 is operating above 80% of capacity; 75 degrees if that array is operating between 40% and 79% of capacity; and 78 degrees if that array is operating below 40% of capacity.

By metering and controlling individual circuits or collections of circuits, the system can give a LSE the ability to charge different rates depending upon end use, for example, the charging a higher rate for air conditioning and a lower rate for all other uses. The system will also allow the utility to selectively disconnect specific circuits based upon usage, so if a customer fails to pay their electric bill, all service except, for example, an air handler could be remotely disconnected.

Rate structures could be even more complex. For example, rates for air conditioning usage could be tiered (e.g. after 600 kWh of usage, the air conditioner rate rises from $0.12/kWh to $0.17/kWh), but rates for the rest of the home could be flat or on a less punitive rate schedule. Similarly, the utility could provide “basic” electrical service, just as a telephone utility does, at a lower price for financially disadvantaged households. The utility could also selectively disconnect non-critical loads in the case of non-payment.

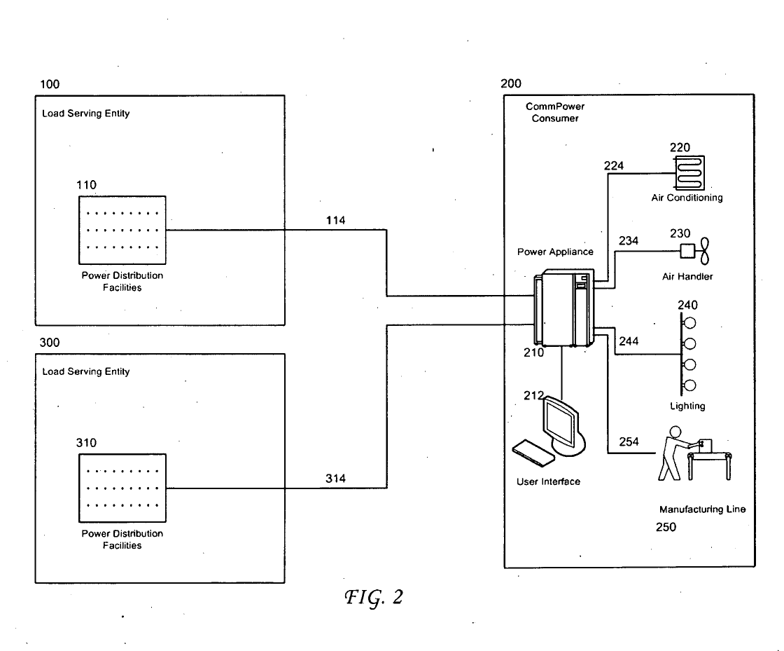

The system described herein may also be applied where an end consumer has access to power from more than one LSE. Referring next to FIG. 2, in another embodiment of the invention, the consumer, 200, has access to power from 2 LSE's. The LSE's may be utilities or private resellers of electrical power obtained from various sources. Where the LSE's have differing rate structures based on usage, the power appliance, 210, can optimize power consumption.

For example, one LSE, 100, may charge $0.16/kWh for air conditioner use and $0.11/kWh for all other uses, and a second LSE, 300, may charge $0.22/kWh for air conditioner use and $0.09/kWh for all other uses. A consumer may purchase power for air conditioning from LSE 100 and power for all other uses from LSE 300 using the system described herein.

In another example, there are times when a LSE has excess electrical capacity available and must either reduce generation or increase load. The LSE, either because they cannot reduce the excess capacity or because there is a non-zero cost associated with reducing that capacity, may pay their customers to increase their load on the grid. The LSE 100 can send information in the form of a notification through its power appliance control point 120 to the power appliance 210, and the power appliance 210 may execute a series of commands to add more load to the system by, for example, lowering the thermostat temperature in order to engage the air conditioning system, energizing a circuit which powers a pool pump, or otherwise causing the loads under its control to consume more power.

In another example, assume a first power customer of the local utility has obtained a flat rate schedule of $0.12/kWh, and is also authorized as a reseller. The first customer may act in the role of an LSE. Assume a second power customer has a Time of Usage rate schedule with the local utility, such that off the peak rate is $0.06/kWh and the peak rate is $0.19/kWh. During off peak periods, the second commercial customer may choose to purchase power during peak periods from the first commercial customer for $0.12/kWh, and off-peak from the utility for $0.06/kWh.

While in the above examples the sole cost criteria is the price of a kilowatt-hour of electricity, the cost could also be calculated using, but not limited to, the following non-monetary factors: power factor, instantaneous demand, environmental tax, or environmental impact.

While the invention has been particularly shown and described with reference to preferred embodiments thereof, it will be understood by those skilled in the art that various changes in form and details may be made therein without departing from the spirit and scope of the invention.

We claim:

1. A power consumption management system comprising:
at least one power appliance operatively connected to a communications network and to a power grid operatively connected to a power source, each of the at least one power appliances being further operatively connected to at least one electrical circuit,
wherein the at least one power appliance is configured to receive power from the power grid and distribute the power to the at least one electrical circuit,
wherein the at least one power appliance is further configured to measure power consumption on the at least one electrical circuit and to transmit data relating to power consumption on the at least one electrical circuit over the communications network
wherein the at least one power appliance is further configured to increase or decrease power supplied to the at least one electrical circuit in response to power consumption commands received over the communications network; and
a power appliance control point operatively connected to the network,
wherein the power appliance control point is configured to receive the data relating to power consumption on the at least one electrical circuit transmitted over the network by the at least one power appliance,
wherein the power appliance control point is further configured to transmit power consumption commands over the network to the at least one power appliance to increase or decrease power supplied to the at least one electrical circuit.

2. The power consumption management system of claim 1,
wherein the power appliance control point is further configured to receive data relating to conditions on the power grid and the status of the power source;
wherein the power appliance control point is further configured to transmit the data relating to conditions on the power grid and the status of the power source over the network;
wherein the power appliance control point is further configured to transmit power consumption commands that program the at least one power appliance to increase or decrease power supplied to the at least one electrical circuit in response to conditions on the power grid or changes to the status of the power source;
wherein the at least one power appliance is further configured to receive the data relating to conditions on the power grid and the status of the power source transmitted over the network by the at least one power appliance control point; and
wherein the at least one power appliance is further configured to receive the data relating to conditions on the power grid and the status of the power source transmitted over the network by the at least one power appliance control point.

3. The power consumption management system of claim 1,
wherein the at least one power appliance is operatively connected to control at least one power consuming device;
wherein the at least one power appliance is further configured to issue the device command to cause the power consuming device appliance to modify its power consumption behavior in response to power consumption commands received over the network.

4. The power consumption management system of claim 3, wherein the device command instructs the at least one power consuming device to change behavior, resulting in an increase or decrease in power consumption.

5. The power consumption management system of claim 3, wherein the device command is a program that instructs the at least one power consuming device to exhibit complex power consumption behavior.

6. The power consumption management system of claim 1, wherein the power appliance control point is configured to use the data relating to power consumption on the at least one electrical circuit to separately meter each electrical circuit connected to the at least one power appliance.

7. The power consumption management system of claim 1,
wherein the at least one power appliance is operatively connected to at least one power consuming device;
wherein the least one power consuming device is configured to modify its power consumption behavior in response to a device command; and
wherein the at least one power appliance is further configured to issue the device command to the at least one power consuming device appliance to modify its power consumption behavior in response to power consumption commands received over the network.

8. A method for managing power consumption comprising the steps:
measuring, using a power appliance, power consumption on at least one electrical circuit;
transmitting data, over a network, relating to the power consumption on the at least one electrical circuit;
receiving data, over a network, relating to power consumption on at least one electrical circuit from a power appliance that manages the at least one electrical circuit;
transmitting at least one command, over the network, to the power appliance, said command commanding the power appliance to increase or decrease the power consumption on the at least one electrical circuit.

9. A method for charging a user for power consumption by electrical circuit:
measuring, using a power appliance, power consumption on each of a plurality of electrical circuits within a user location;
transmitting data, over a network, relating to the power consumption on each of the plurality of electrical circuits within the user location to a power appliance control point;
metering, using the power appliance control point, the power consumption on each of the plurality of electrical circuits; and,
charging the user for power consumption on each of the of the plurality of electrical circuits using a rate structure having a rate for each of the of the plurality of electrical circuits.

10. The method of claim 8, wherein the rate charged for at least one of the plurality of electrical circuits is different than the rate charged for at least one other of the plurality of electrical circuits.

11. The method of claim 9, wherein the rate charged for at least one of the plurality of electrical circuits is different than the rate charged for at least one other of the plurality of electrical circuits.

12. A power consumption management system, comprising:
a power appliance operatively connected to a network, to a plurality of power sources, and to a plurality of electrical circuits,
wherein the power appliance is configured to receive power from the each of the plurality of power sources, and
wherein the power appliance is further configured to separately select, for each of plurality of electrical circuits, one of the plurality of power sources, and to distribute power to each of the plurality of electrical circuits from the one of the plurality of power sources selected for that electrical circuit.

13. The power consumption management system of claim 12, wherein the power appliance is configured to select the lowest cost power source from the plurality of power sources for each of the selected electrical circuits.

14. The power consumption management system of claim 12, wherein the power appliance is configured to select the power source from the plurality of power sources that maximizes a non-monetary factor for each of the selected electrical circuits.

15. The power consumption management system of claim 14, wherein the non-monetary factor is selected from the list: power factor, instantaneous demand, environmental tax, and environmental impact.

16. The power consumption management system of claim 12, wherein each of the plurality of electrical circuits is associated with a type of usage and each power source has a rate schedule that specifies differing rates for specific types of usage, wherein the power appliance uses the rate schedule for each of the plurality of power suppliers to select the power source for each of the plurality of electrical circuits.

17. The power consumption management system of claim 12 wherein each power source has a rate schedule that specifies differing rates for times of usage, wherein the power appliance uses the rate schedule for each of the plurality of power suppliers to select the power source for each of the plurality of electrical circuits.

18. The power consumption management system of claim 12, wherein an entity associated with the power appliance is able to resell power from at least one of the plurality of power sources and the power appliance is further configured to resell power from at least one of the plurality of power sources to at least one power consumer.

19. A method for managing power consumption comprising the steps:
receiving, on a power appliance, power from a plurality of power sources;
selecting, using the power appliance, one of the plurality of power sources for each of a plurality of electrical circuits;
distributing power from the selected one of the plurality of powers sources to each of the plurality of electrical circuits;

20. The method of claim 19, wherein lowest cost power source is selected from the plurality of power sources for each of the selected electrical circuits.

21. The method of claim 19, wherein the power source is selected from the plurality of power sources that maximizes a non-monetary factor for each of the selected electrical circuits.

22. The method of claim 21, wherein the non-monetary factor is selected from the list: power factor, instantaneous demand, environmental tax, and environmental impact.

23. The method of claim 20, wherein each of the plurality of electrical circuits is associated with a type of usage and each power source has a rate schedule that specifies differing rates for specific types of usage, wherein the rate schedule for each of the plurality of power suppliers is used to select the power source for each of the plurality of electrical circuits.

24. The method of claim 20, wherein each power source has a rate schedule that specifies differing rates for times of usage, wherein the power appliance uses the rate schedule for each of the plurality of power suppliers to select the power source for each of the plurality of electrical circuits.
